(19) United States
(12) Patent Application Publication
(10) Pub. No.: US 2026/0230028 A1
(43) Pub. Date: Aug. 6, 2026

(54) FISHBONE SUPPORTS FOR SOLAR PHOTOVOLTAIC PANELS

(71) Applicant: SAUDI ARABIAN OIL COMPANY, Dhahran (SA)

(72) Inventors: Marwan Abdullah, Thuwal (SA); Brian Parrott, Thuwal (SA); Konstantinos Kotsovos, Thuwal (SA)

(73) Assignee: SAUDI ARABIAN OIL COMPANY, Dhahran (SA)

(21) Appl. No.: 19/045,189

(22) Filed: Feb. 4, 2025

(30) Foreign Application Priority Data
Feb. 4, 2025 (GR) 20250100079

(51) Int. Cl. H02S 20/20; F16B 7/04; F16B 7/18

(52) U.S. Cl. CPC H02S 20/20; F16B 7/0446; F16B 7/187

(57) ABSTRACT

A photovoltaic assembly including at least one fishbone support, at least one solar photovoltaic (PV) panel adhered to the at least one fishbone support and at least one additional support selected from the group consisting of a horizontal support configured to support the at least one fishbone support and attached to the backbone, wherein the horizontal support comprises a profiled slot, a vertical support attached to the plurality of cross arms, and combinations thereof. The at least one fishbone support includes a backbone and a plurality of cross arms attached to and arranged perpendicular to the backbone. a method for shipping photovoltaic including providing a photovoltaic assembly including at least one fishbone support adhered to a backside of at least one solar PV panel as a first layer and stacking additional photovoltaic assemblies along raised portions to generate subsequent layers of photovoltaic assemblies.

### BACKGROUND

Solar panels are typically mass-manufactured in factories and then shipped to the field where they will be deployed, often traveling half-way around the world before reaching their destination. As such, the logistical costs involved with loading, transporting, unloading, and deploying these panels can be a significant portion of the total cost of the solar power plant. One way to reduce these costs dramatically is by reducing the weight of the solar panels.

Additionally, while solar panels aim to reduce emissions via renewable power generation, there is a non-trivial amount of energy and resources that go into manufacturing solar panels, each of which adds to the amount of emissions arising from the fabrication of the solar panels. The cost of logistics (described above) is further linked to emissions. As reducing the weight (material and logistics) of the solar panels will reduce emissions, using alternate, fewer and lighter materials could also support emissions reductions.

Current fabrication materials include the use of non-metallic (polymeric) materials in the assembly of solar panels that avoid, or reduce, the use of aluminum and glass. However, aluminum is a fairly light-weight and rigid material, and glass is also stiff. If both aluminum and glass are removed from the solar panels, it is important to replace them with support structure(s) and suitable materials that maintain an appropriate stiffness while reducing the embodied energy and weight.

Accordingly, there exists a need for a new support structure to reduce the amount of support material while ensuring the mechanical robustness of the solar panel that would otherwise be provided by a conventional aluminum frame or thick glass sheets.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a photovoltaic assembly including at least one fishbone support, at least one solar photovoltaic (PV) panel adhered to the at least one fishbone support and at least one additional support selected from the group consisting of a horizontal support configured to support the at least one fishbone support and attached to the backbone, wherein the horizontal support comprises a profiled slot, a vertical support attached to the plurality of cross arms, and combinations thereof. The at least one fishbone support includes a backbone and a plurality of cross arms attached to and arranged perpendicular to the backbone.

In another aspect, embodiments disclosed herein relate to a method for shipping photovoltaic assemblies, the method including providing a photovoltaic assembly including at least one fishbone support adhered to a backside of at least one solar PV panel as a first layer and stacking additional photovoltaic assemblies along raised portions to generate subsequent layers of photovoltaic assemblies, where the at least one fishbone support includes a backbone, a plurality of cross arms attached to and arranged perpendicular to the backbone, and raised portions attached at least a portion of the plurality of cross arms and/or the backbone.

Other aspects and advantages of the claimed subject matter will be apparent from the following description and the appended claims.

### BRIEF DESCRIPTION OF DRAWINGS

FIG. 1 shows a fishbone support structure adhered to a photovoltaic panel in accordance with one or more embodiments.

FIG. 2 shows a cross-sectional view of a photovoltaic assembly in accordance with one or more embodiments.

FIGS. 3A-3D show backbone attachment mechanisms in accordance with one or more embodiments.

FIG. 4 shows a cross-sectional view of photovoltaic assembly in accordance with one or more embodiments.

FIGS. 5A-B show stacking configurations of photovoltaic assemblies in accordance with one or more embodiments.

### DETAILED DESCRIPTION

Throughout the application, ordinal numbers (for example, first, second, third) may be used as an adjective for an element (that is, any noun in the application). The use of ordinal numbers does not imply or create a particular ordering of the elements or limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “a horizontal beam” includes reference to one or more of such beams.

Terms such as “approximately” or “substantially” mean that the recited characteristic, parameter, or value need not be achieved exactly, but that deviations or variations, including, for example, tolerances, measurement error, measurement accuracy limitations, and other factors known to those of skill in the art, may occur in amounts that do not preclude the effect the characteristic was intended to provide.

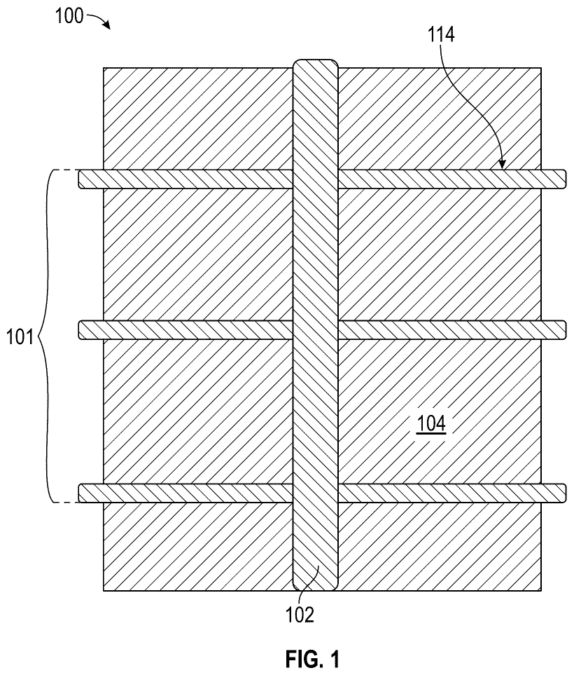

In the following description of FIGS. 1-5, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Embodiments herein discuss backbone structures with integrated attachment mechanisms that facilitate installation and reduce the number of pieces that need to be assembled in the field. The backbone structure and assembly discussed herein allow for enhanced packing and protection during shipping. As used herein, “include” means “include, but not limited to”.

In one aspect, embodiments disclosed herein relate to a photovoltaic assembly that includes at least one fishbone support and at least one solar PV panel adhered to the at least one fishbone support. The fishbone support may include at least one backbone and a plurality of cross arms attached to the first side of the backbone and arranged perpendicular to the backbone. The backbone may include a first side, a second side, and a profiled fitting configured to engage with a profiled slot. The photovoltaic assembly may also include at least one additional support selected from a horizontal support, a vertical support or combinations thereof. The horizontal support may be configured to support the at least one fishbone support and attached to the second side of the backbone. The horizontal support may also include a profiled slot. The vertical support may be attached to the plurality of cross arms.

According to one or more embodiments, the fishbone support may be a single piece. The single piece may be formed using any suitable method, including injection molding and extrusion. Alternatively, the fishbone may comprise its numerous components as separate pieces adhered together, such as a molded or extruded backbone adhered to molded cross arms. The single molded or extruded piece, or the separately molded and/or extruded pieces may be in the form of a polymerized material or derived from a polymer. However, it is also envisioned that the fishbone support may be in the form of a single non-metallic piece or formed of several non-metallic pieces. It is also envisioned that the support may be formed from a combination of polymeric, metallic and/or non-metallic based materials. For instance, the backbone, the plurality of cross arms, the profiled fitting (e.g. molded T) and the raised portions may be a single molded or extruded polymeric piece that provides a lighter weight support structure for a glass or polymer based solar PV panel. Any suitable polymeric material may be used. As a non-limiting example, a polymeric material used to form a molded or extruded backbone or single piece may be polycarbonate. The single molded polymeric piece may therefore contribute sufficient rigidity and robustness while maintaining a lightweight structure with reduced material. Further, the integrated attachment mechanism into the backbone structure may facilitate installation and reduce the number of pieces that need to be assembled in the field.

As mentioned above, the photovoltaic assembly may comprise at least one fishbone support. As shown in FIG. 1, the photovoltaic assembly 100 includes at least one fishbone support 101, also referred to herein as the fishbone support or fishbone structure and at least one solar PV panel 104. The fishbone support may include a backbone 102 and a plurality of cross arms 114. While the plurality of cross arms 114 shown in FIG. 1 are arranged perpendicular to the backbone, they may be arranged in any suitable configuration to support the solar PV panel. Further, while FIG. 1 shows 3 cross arms, the embodiments disclosed herein are not limited to that number of cross arms nor in an equally spaced configuration. Rather, the fishbone support may comprise any suitable number of more or less cross arms to support the solar PV panel. The fishbone support may also include the plurality of cross arms at any suitable spacing needed to support the solar PV panel. For example, the outermost arms may be near or at the top edge and/or bottom edge of the solar PV panel and anywhere in between as long as the panel is adequately supported.

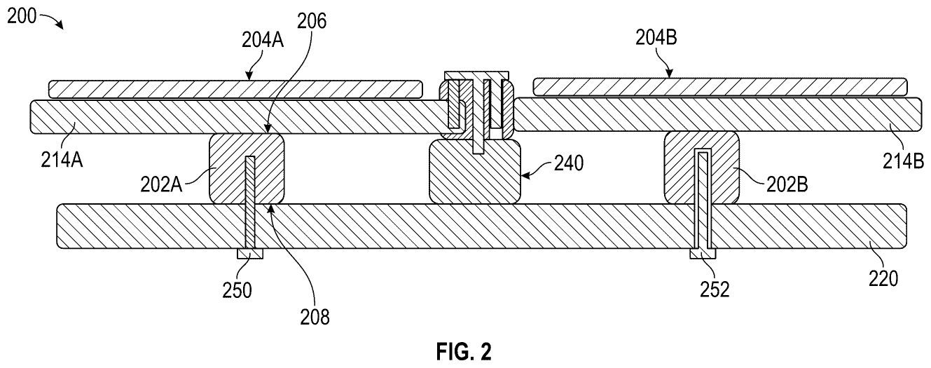

As mentioned above, the fishbone support may be adhered to a solar photovoltaic (PV) panel. As shown in FIG. 2, the photovoltaic assembly 200 includes two different solar PV panels (204A, 204B), where the backside of the two panels may be adhered to the plurality of cross arms (214A, 214B) of different backbones (202A, 202B). While only two backbones of two different fishbone supports and two different PV panels are shown, it is understood that any suitable number of fishbone supports and any suitable corresponding number of PV panels may be used.

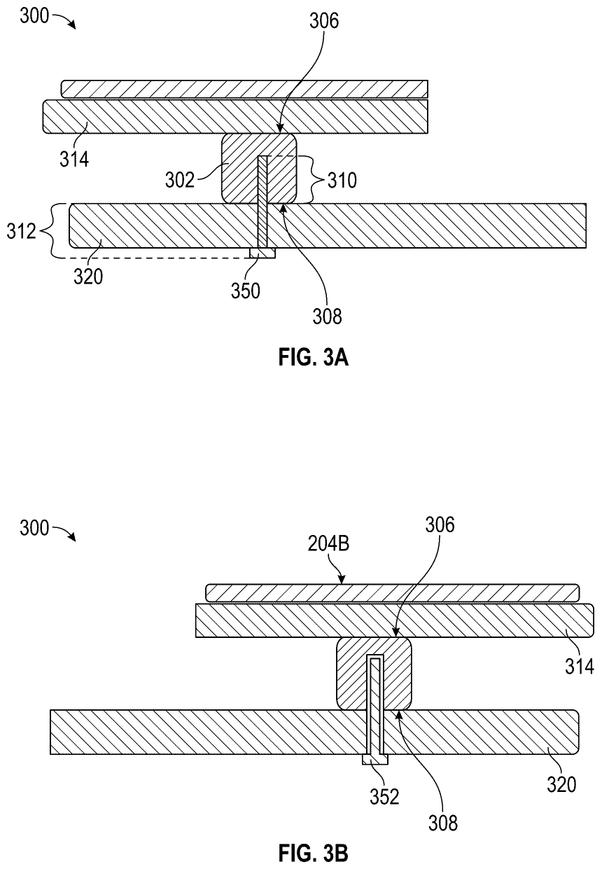

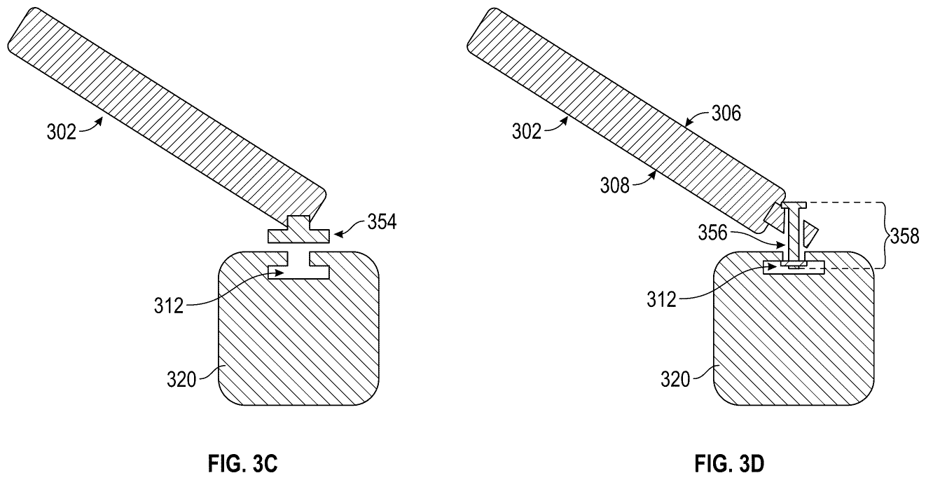

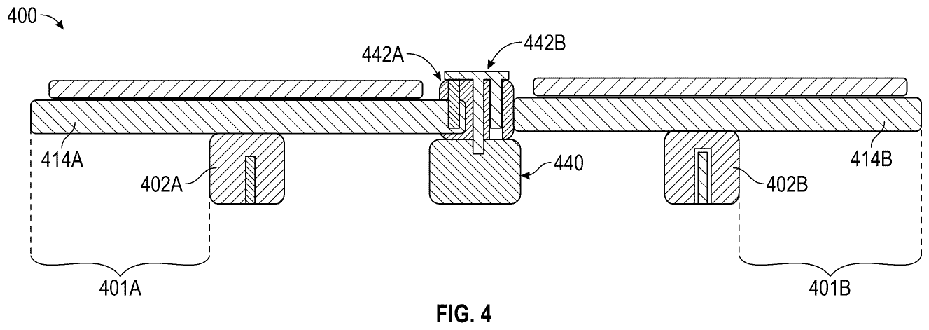

Each backbone of the at least one fishbone support may include a first side and a second side. In keeping with FIG. 2, the backbone 202A may include a first side 206 where the plurality of cross arms may be attached. Opposite from the first side 206, and as noted above, the backbone 202A may include a second side 208 that attaches the backbone to a horizontal support 220. As noted above, the photovoltaic assembly may comprise at least one additional support selected from a horizontal support and a vertical support. Thus, while FIG. 2 includes a photovoltaic assembly 200 with both a horizontal support 220 attached to the backbones 202A,B and a vertical support 240 attached to the plurality of cross arms from different backbones, it is also envisioned that the photovoltaic assembly may include solely the horizontal support, as shown in FIGS. 3A-D, or solely the vertical support as shown in FIG. 4. Further, the horizontal support and the vertical support may be connected through any suitable method including a traditional racking setup, where the horizontal support holds up the vertical supports (or vice versa) via standard connections-including screws (as shown in FIG. 2), corner brackets with T-nuts, other holders or combinations thereof.

While FIG. 2 shows the plurality of arms adhered to the first side 206 of the backbone 204A and the second side 208 of the backbone adhered to the horizontal support (an offset configuration), the connection formed between the first side of the backbone 206 and the plurality of arms 214 may be replaced by a single piece fishbone support. Thus, it is also envisioned that the plurality of cross arms and the backbone form a single piece such that the second side 208 may be in plane with the backside of the plurality of cross arms. In this configuration, the backbone may include a number of individual segments between the plurality of cross arms rather than disposed between the plurality of arms 214 and the horizontal support 220. When the backside of the plurality of cross arms are in plane with the horizontal support, it is also envisioned that the vertical support may be comprised of one or more segments disposed between the horizontal supports. This configuration allows for the entire backside of the fishbone support (backbone and plurality of arms) to be in plane with the horizontal support and optionally the vertical support. The backbone of the fishbone support may include integrated mounting points. According to one or more embodiments, the horizontal support may be configured to support the at least one fishbone support and attached to the second side of the backbone. As shown in FIGS. 3A and 3B, the photovoltaic assembly 300 includes the horizontal support 320 which may be attached to the second side 308 of the backbone 302 with a screw 350 or a molded attachment clamp 352. In this configuration shown FIG. 3A, the profiled fitting 310 of the backbone and the profiled slot 312 of the horizontal support 320 may be a hole or a plurality of holes configured to align and receive a fastener. When the profiled fitting and the profiled slot are aligned, the fastener may be a screw 350 or the molded attachment clamp 352 may be used to secure the horizontal support to the backbone. However, any suitable fastener may be used to secure the backbone to the horizontal support.

According to one or more embodiments, the profiled fitting may be a molded profiled fitting attached to the backbone. As shown in FIG. 3C, the profiled fitting may be a molded T 354 that may engage with a corresponding T-slot 312 of the horizontal support 320. The molded T 354 may therefore slide into position along the T-slot 312 of the horizontal support 320.

The profiled fitting may also include a molded attachment hole as part of the backbone. As shown in FIG. 3D, the profiled fitting may be a molded attachment hole 356 that would enable fasteners such as standard bolts and nuts 358 to be used for easy attachment to the horizontal supports T-slot 312. In these embodiments, the bolt 358 may slide into the attachment hole of the backbone and extend into the T-slot 312 of the horizontal support 320 to engage with the nut. When the nut is wider than the opening of the T-slot, the bolt and nut can be tightened to secure the backbone 302 to the horizontal support 320. While only a few embodiments are shown for attaching the backbone to the horizontal support, it is understood that any suitable fastening feature or combinations thereof may be used to attach the respective parts.

Further, while FIGS. 1-3D only show a single or two backbones connected to a horizontal support, the horizontal support may be connected to a plurality of backbones (e.g. more than two). Accordingly, the horizontal support may be any suitable length to support any suitable number of fishbone supports and to form a structurally stable and integrated system/array. When a plurality of backbones are supported by a horizontal support, each backbone may include the same or combinations of different profiled fittings. Thus, the profiled fittings may be at least one of a fastener, a screw, a nut and bolt, a molded T, an attachment hole or combinations thereof.

In keeping with FIGS. 3A-3D, the backbone may be attached to the horizontal support in a plurality of configurations. As shown in FIGS. 3A and 3B, the backbone may be oriented such that the first and second sides of backbone of the fishbone support are flush with the plurality of cross arms 314 and the horizontal support 320, respectively. In this configuration, the backbone may be, but is not limited to being, perpendicular to and between the horizontal support and the plurality of cross arms. However, and as shown in FIGS. 3C and 3D, the backbone may be oriented such that the backbone is titled at an angle away from the horizontal support. When the backbone is tilted at an angle, the second side 308 of the backbone is no longer flush with the horizontal support 320. Further, the integrated mounting mechanisms may provide the backbone to be attached to the horizontal support at any suitable angle as long as the photovoltaic assembly maintains sufficient rigidity.

The above-described assembly may also comprise a vertical support that acts as a centralized mounting structure for the plurality of cross arms to provide essential support to the edges of the PV panels. As shown in FIG. 4, the photovoltaic assembly 400 may include different fishbone supports (401A, 401B) attached to one another through the different plurality of cross arms (414A, 414B). The plurality of cross arms 414A and the vertical support 440 may comprise corresponding retaining features to connect different backbones. For instance, as shown in FIG. 4, a first fishbone support 401A may be connected to a second fishbone support 401B. The different fishbone supports may be connected by way of the plurality of cross arms that include corresponding retaining features including, but not limited to, holes for a fastener 442A or fittings for a molded clip 442B. In these embodiments, the plurality of cross arms 414A, 414B may extend past the end/edge of the active face of the solar panel and may include a hole or fitting to receive the screw or molded clip. It is also envisioned that in connecting the different plurality of cross arms, a mixture of holes and molded clips/clamps may be used to attach the plurality of cross arms from the different fishbone supports to the vertical support. Through the centralized mounting of the two different backbones (402A, 402B) by way of the plurality of cross arms 414A, 414B, support is provided to the edge of the solar PV panels. Further, while only two fishbone supports are shown in the cross-sectional view of FIG. 4, it is also envisioned that the vertical support may be any suitable length to support a plurality of different photovoltaic assemblies to form a structurally stable and integrated system/array.

In another aspect, embodiments disclosed herein also related to a method of manufacturing the above-described photovoltaic assembly that includes providing at least one fishbone support structure and at least one solar PV panel and adhering the at least one fishbone support to a backside of the at least one solar PV panel. As a nonlimiting example, an injection molded (single piece) fishbone support may be adhered to the back of an encapsulated solar PV panel with glue or friction welding. Any suitable type of glue including epoxies, or bonding agents, may be used to attach the panel to the skeletal fishbone support. When adhering the panel to the fishbone support using friction welding techniques, the method may include a clamp holding the front panel while another specialized holder may hold the backbone of the fishbone support. The two parts may rotate quickly under pressure to quickly heat the interface to the point that both the molded skeletal fishbone support and the backside of the solar PV panel may melt at the surface resulting in mixing of the materials into a single liquid interface. When the interface cools, it provides a strong bond between the two materials as long as the polymers are compatible (compatibility is well known in the art). As a non-limiting example, the design may incorporate the selection of materials such that the selected material may cause the backbone to melt at a slightly lower temperature, as it is a less sensitive component relative to the solar panel and to ensure that damage the encapsulant of the solar panel is prevented. Thus, the selection of the materials should allow for reaching a point where the panel material may be softened, but not melted, such that fusion may occur without movement of the panel material.

In yet another aspect, embodiments disclosed herein also relate to a method for transporting the photovoltaic assemblies described above. The method may include steps of providing at least one photovoltaic assembly as a first layer and subsequently stacking additional photovoltaic assemblies along raised portions to generate subsequent layers of photovoltaic assemblies. During transportation, the assemblies may be stacked such that the fishbone supports can support the panels and their edges to keep them from shifting. In these embodiments, the fishbone support may further comprise raised portions.

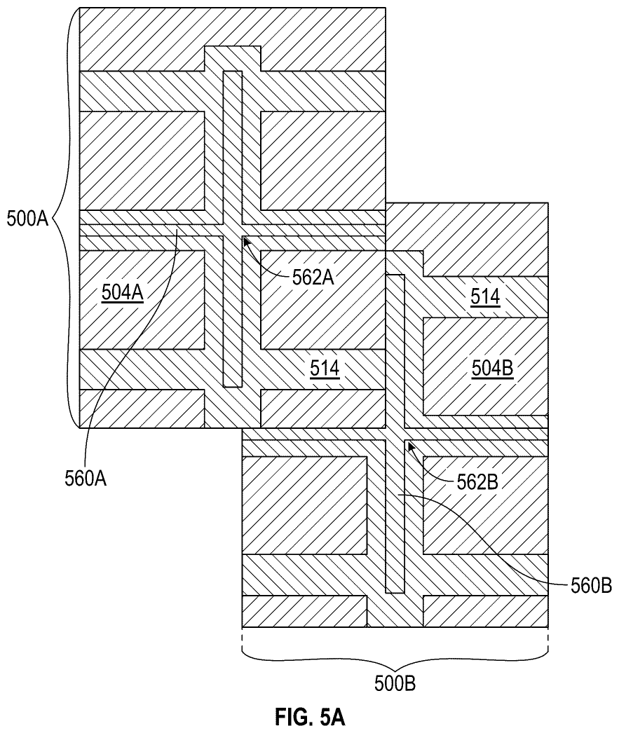

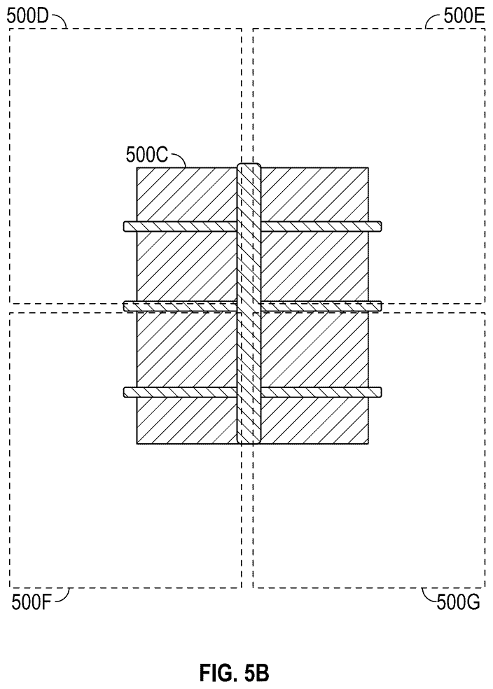

The plurality of cross arms may help with efficient packaging/transport and may have features molded into them that fit around the end of a panel below/above, or flat surfaces to distribute weight efficiently, etc. These features could also be present in the backbone of the fishbone support. As shown in FIG. 5A, the photovoltaic assemblies 500A, 500B may include raised portions 560A, 560B attached to and parallel with at least a portion of the backbone and/or the plurality of cross arms to create corners 562. With the raised portions along portions of the backbone and/or plurality of cross arms, a PV assembly 500A may be well aligned and stacked on another PV assembly 500B such that the edges and corners of the panel 504A rest along the raised portions 560B and on the corners 562B of the second PV panel 504B beneath it. While only one PV assembly is shown stacked on a second PV assembly in FIG. 5A, the raised portions of the first/bottom layer PV assembly may allow for the alignment and stacking of a plurality of assemblies as shown in FIG. 5B. In FIG. 5B, four separate PV assemblies (500D, 500E, 500F, 500G) form a second layer stacked on top of a single PV assembly (500C) as a first layer. Each of the top layers of the four photovoltaic assemblies are arranged such that the corners and edges of each panel are protected by the raised portions of the PV assembly beneath it. Thus, the corner and edges of the individual PV assemblies may share different spaces of the same raised portion of the layer beneath it.

As each solar PV panel is adhered to a fishbone support, each of the PV assemblies may also comprise raised portions to allow for the continued stacking of additional layers of photovoltaic assemblies. According to one or more embodiments, the assemblies may be stacked in a transportation efficient configuration that includes a repeating or alternating pattern. According to one or more embodiments, the alternating pattern may include a -1-4-1-4-configuration, where the first and second layers resemble that shown in FIG. 5B. However, the embodiments may include any suitable repeating or alternating pattern to ensure both a stable and more efficient packing system for transportation. For instance, the stacking configuration may be modified to accommodate the size and dimensions of any suitable structure used to ship or transport the photovoltaic assemblies. For shipping/transportation purposes, separate protection may be provided to protect the outer edges of the PV assemblies from the structure used to ship or transport the photovoltaic assemblies.

Embodiments of the present disclosure may provide at least one of the following advantages. The skeletal fishbone support structure may provide reinforcement of solar panel backing. The central support of the backbone and radiating reinforcing arms provide enhanced mechanical robustness while reducing emissions and weight of the overall solar panel assembly. The embodiments make it feasible to manufacture panels without any metals for reinforcing the panel while also reducing the weight of reinforcing material needed. This should make the panels lighter, more cost-effective, and to use more oil-derived polymers than current glass-based technologies. The embodiments disclosed herein may thereby provide significant improvements in the logistical costs for solar panel loading, transport, unloading and deployment.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A photovoltaic assembly comprising:
at least one fishbone support;
at least one solar PV panel adhered to the at least one fishbone support,
wherein the at least one fishbone support comprises:
a backbone; and
a plurality of cross arms attached to and arranged perpendicular to
the backbone; and
at least one additional support selected from the group consisting of:
a horizontal support configured to support the at least one fishbone support and attached to the backbone, wherein the horizontal support comprises a profiled slot,
a vertical support attached to the plurality of cross arms, and
combinations thereof.

2. The assembly of claim 1, wherein the backbone comprises a profiled fitting configured to engage with a profiled slot.

3. The assembly of claim 2, wherein the assembly comprises the horizontal support and wherein the profiled fitting and the profiled slot comprise holes configured to align and receive a fastener.

4. The assembly of claim 3, wherein the fastener comprises a screw or a clamp.

5. The assembly of claim 1, wherein the assembly comprises the horizontal support and the profiled slot comprises a T-slot.

6. The assembly of claim 2, wherein the profiled fitting is selected from the group consisting of a screw, a nut and bolt, a molded T, an attachment hole and combinations thereof.

7. The assembly of claim 6, wherein the profiled fitting comprises a molded T.

8. The assembly of claim 6, wherein the profiled fitting comprises an attachment hole configured to receive a nut and bolt to engage with the T-slot.

9. The assembly of claim 1, wherein the assembly comprises the vertical support and wherein the plurality of cross arms and the vertical support comprise corresponding retaining features to connect the plurality of cross arms from different backbones.

10. The assembly of claim 9, wherein the corresponding retaining features comprises at least one of molded clips or holes configured to receive a fastener.

11. The assembly of claim 1, wherein the assembly comprises the horizontal support and the vertical support.

12. The assembly of claim 1, wherein the at least one fishbone support comprises the backbone and the plurality of cross arms as a single molded piece.

13. The assembly of claim 12, wherein the single molded piece is derived from a polymer.

14. The assembly of claim 1, wherein the at least one fishbone support further comprises raised molded portions.

15. A method of manufacturing a photovoltaic assembly, the method comprising:
providing at least one support structure and at least one solar PV panel; and
adhering the at least one fishbone support to a backside of the at least one solar PV panel thereby forming the assembly of claim 1.

16. A method for shipping photovoltaic assemblies, the method comprising:
providing a photovoltaic assembly comprising at least one fishbone support adhered to a backside of at least one solar PV panel as a first layer;
wherein the at least one fishbone support comprises:
a backbone
a plurality of cross arms attached to and arranged perpendicular to the backbone; and
raised portions attached at least a portion of the plurality of cross arms and/or the backbone, and
stacking additional photovoltaic assemblies along the raised portions to generate subsequent layers of photovoltaic assemblies.

17. The method of claim 16, wherein stacking additional photovoltaic assemblies comprises resting each photovoltaic assembly at corners formed with the raised portions.

18. The method of claim 16, wherein the first layer and subsequent layers form an alternating pattern.

19. The method of claim 18, wherein the alternating pattern comprises a -1-4-1-4 -configuration.
